(19) United States
(12) Patent Application Publication
(10) Pub. No.: US 2017/0183613 A1
(43) Pub. Date: Jun. 29, 2017

(54) EMULSIFIED FLAVOR COMPOSITION FOR ALCOHOLIC BEVERAGES

(71) Applicant: Takasago International Corporation, Tokyo (JP)

(72) Inventors: Takeshi NAKAMURA, Kanagawa (JP); Yuya TAMAI, Kanagawa (JP)

(73) Assignee: Takasago International Corporation, Tokyo (JP)

(21) Appl. No.: 15/378,377

(22) Filed: Dec. 14, 2016

(30) Foreign Application Priority Data
Dec. 24, 2015 (JP) 2015-252241

(51) Int. Cl. C12G 3/06; A23L 27/00

(52) U.S. Cl. CPC C12G 3/06; A23L 27/80; A23V 2002/00

(57) ABSTRACT

The present invention relates to an emulsified flavor composition for an alcoholic beverage that does not generate a floating matter or a sediment, that maintains a stable emulsified state, that imparts transparent appearance to the alcoholic beverage and that does not impair the taste/flavor of the alcoholic beverage, even when mixed with a concentrated syrup that has an alcohol concentration several times higher than that of the alcoholic beverage during the steps for producing the alcoholic beverage. The emulsified flavor composition for alcoholic beverages of the present invention comprises: (a) an oil-soluble component containing a flavor; (b) a polyglycerol fatty acid ester whose 1% by weight aqueous solution has transmittance of 65% or higher at 600 nm; and (c) lecithin.

### TECHNICAL FIELD

The present invention relates to an emulsified flavor composition for alcoholic beverages, and an alcoholic beverage and a concentrated syrup for alcoholic beverages containing a high-concentration alcohol containing the same.

### BACKGROUND ART

As a method for imparting taste/flavor to a beverage, an emulsified flavor obtained by emulsifying an oil-soluble flavor is widely used. An emulsified flavor is capable of imparting durable taste/flavor that differs from those imparted by water-soluble flavors. Recently, opportunities for using emulsified flavors for alcoholic beverages having transparent appearance such as shochu (Japanese distilled alcohol)-based beverages, sours, cocktails, sweetened fruit wine, other miscellaneous liquors and liqueurs as well as for soft drinks such as sports drinks and fruit juice drinks are increasing. Since the transparent appearance of these products is part of their commercial value, the emulsified flavor added for the purpose of imparting taste/flavor should be one that is capable of transparent dispersion.

In addition, since an emulsified flavor used for an alcoholic beverage needs to be added to a concentrated syrup that has a concentration several times higher than a concentration of an alcoholic beverage during the steps for producing the alcoholic beverage, emulsion stability in a high-concentration alcohol is required. Usually, the concentration rate is about 4 to 6 times, where if an alcohol concentration of an alcoholic beverage is 7%, an alcohol concentration of a five-times concentrated syrup is 35%.

In general, ethanol contained in an alcoholic beverage is known to have an adverse effect on emulsion stability. It is believed that this is because ethanol dissolves mutually in both oil and aqueous phases, and therefore (i) the boundary becomes unclear, (ii) liquid droplets cannot be maintained because orientation of the emulsifier is inhibited, and (iii) movement of the substance due to mutual solubility promotes separation into two phases, i.e., oil and water. Accordingly, even if there may be no problem in emulsion stability when an emulsified flavor is used for a soft drink, adequate emulsion stability may not be obtained in a high-concentration alcohol solution, and thus even the same emulsified flavor may not equivalently be suitable for use in alcoholic beverages. Therefore, in order to obtain an emulsified flavor for alcoholic beverages, studies also requires consideration for the steps for producing an alcoholic beverage. In other words, emulsion stability in a high-concentration alcohol solution is required.

As an emulsified flavor that can maintain a flavor of an alcoholic beverage product or a carbonated beverage product and that has emulsion stability and transparency, an emulsified composition comprising 0.1-2% by weight of enzymatically modified lecithin, 3-10% by weight of a polyglycerol fatty acid ester, 1-5% by weight of sucrose fatty acid ester, 50-85% by weight of polyhydric alcohol, 1-10% by weight of water and 1-10% by weight of a flavor has been proposed (Japanese Patent No. 4563438, Patent Literature 1). Moreover, as emulsified flavors having high transparency and resistance to acid, heat and alcohol, a hydrophilic polyglycerol fatty acid ester with HLB of 10 or more, a lipophilic polyglycerol fatty acid ester with HLB of 8 or less and an emulsified flavor composition containing lysolecithin have been proposed (Japanese Patent No. 5588048, Patent Literature 2).

These emulsified compositions or emulsified flavor compositions, however, do not have the emulsion stability that is required in a high-concentration alcohol solution, and thus they are insufficient as an emulsified flavor that imparts transparent appearance to an alcoholic beverage and that does not impair the taste/flavor of the alcoholic beverage.

### CITATION LIST

### Patent Literature

[Patent Literature 1] Japanese Patent No. 4563438

[Patent Literature 2] Japanese Patent No. 5588048

### SUMMARY OF INVENTION

### Technical Problem

Under such circumstances, there has been a need for an emulsified flavor for an alcoholic beverage that does not generate a floating matter or a sediment, that maintains a stable emulsified state, that imparts transparent appearance to the alcoholic beverage and that does not impair the taste/flavor of the alcoholic beverage, even when mixed with a concentrated syrup that has an alcohol concentration several times higher than that of the alcoholic beverage during the steps for producing the alcoholic beverage.

### Solution to Problem

The present inventors have gone through keen studies to solve the above-described problem, as a result of which found that it is favorable to use a combination of a polyglycerol fatty acid ester and lecithin as an emulsifier for an oil-soluble component containing a flavor. The present inventors also found that although HLB (Hydrophilic-Lipophilic Balance) is generally used as a measure for representing a nature of a surfactant such as a polyglycerol fatty acid ester, a favorable polyglycerol fatty acid ester that solves the above-described problem cannot be selected according to HLB, and that a polyglycerol fatty acid ester whose 1% by weight aqueous solution has transmittance of 65% or higher at 600 nm can desirably be used, thereby achieving the present invention.

Thus, the present invention provides an emulsified flavor composition for alcoholic beverages, and an alcoholic beverage and a concentrated syrup for alcoholic beverages comprising the same, and the like, stated below.

[1] An emulsified flavor composition for alcoholic beverages, comprising:

(a) an oil-soluble component containing a flavor;

(b) a polyglycerol fatty acid ester whose 1% by weight aqueous solution has transmittance of 65% or higher at 600 nm; and

(c) lecithin.

[2] The emulsified flavor composition for alcoholic beverages according to [1], wherein (c) the lecithin is not enzymatically modified.
[3] The emulsified flavor composition for alcoholic beverages according to either one of [1] and [2], wherein (b) the polyglycerol fatty acid ester is an ester of decaglycerol and a fatty acid selected from stearic acid, oleic acid or a combination thereof.
[4] The emulsified flavor composition for alcoholic beverages according to any one of [1] to [3], which comprises 20-135 parts by weight of (c) the lecithin to 100 parts by weight of (b) the polyglycerol fatty acid ester.
[5] An alcoholic beverage comprising the emulsified flavor composition according to any one of [1] to [4].
[6] A concentrated syrup for alcoholic beverages comprising the emulsified flavor composition according to any one of [1] to [4].
[7] The concentrated syrup for alcoholic beverages according to [6], wherein the alcohol concentration of the concentrated syrup for alcoholic beverages is 20% or higher by volume.
[8] A method for producing an alcoholic beverage by diluting the concentrated syrup according to either one of [6] and [7].

### Advantageous Effects of Invention

An emulsified flavor composition for alcoholic beverages of the present invention can be used to transparently disperse an oil-soluble flavor into an alcoholic beverage. According to a preferable embodiment of the present invention, an emulsified flavor composition for alcoholic beverages of the present invention can be used to provide an alcoholic beverage with high palatability without impairing the taste/flavor of the alcoholic beverage product. In addition, according to a preferable embodiment of the present invention, an emulsified flavor composition for alcoholic beverages of the present invention does not generate a floating matter or a sediment and maintains a stable emulsified state, even when it is mixed with a concentrated syrup with a concentration several times higher than that of an alcoholic beverage during the steps for producing the alcoholic beverage.

### DESCRIPTION OF EMBODIMENTS

An emulsified flavor composition for alcoholic beverages of the present invention comprises: (a) an oil-soluble component containing a flavor; (b) a polyglycerol fatty acid ester whose 1% by weight aqueous solution has transmittance of 65% or higher at 600 nm; and (c) lecithin. The emulsified flavor composition for alcoholic beverages of the present invention is capable of transparently dispersing the oil-soluble flavor in an alcoholic beverage and has excellent emulsion stability in the alcoholic beverage, by comprising the above-mentioned components (a), (b) and (c). Hereinafter, each of the components contained in the emulsified flavor composition for alcoholic beverages of the present invention will be described in detail.

(a) Oil-Soluble Component Containing Flavor

An emulsified flavor composition for alcoholic beverages of the present invention contains (a) an oil-soluble component containing a flavor.

A flavor used in (a) the oil-soluble component containing a flavor is not particularly limited as long as it is generally used for food or a beverage, where examples thereof include synthetic flavors such as esters, alcohols, aldehydes, ketones, acetals, phenols, ethers, lactones, furans, hydrocarbons and acids, and natural flavors.

As esters, for example, acrylic acid esters (methyl, ethyl, etc.), acetoacetic esters (methyl, ethyl, etc.), anisic acid esters (methyl, ethyl, etc.), benzoic esters (allyl, isoamyl, ethyl, geranyl, linalyl, phenyl ethyl, hexyl, cis-3-hexenyl, benzyl, methyl, etc.), anthranilic acid esters (cinnamyl, cis-3-hexenyl, methyl, ethyl, linalyl, isobutyl, etc.), N-methylanthranilic acid esters (methyl, ethyl, etc.), isovaleric acid esters (amyl, allyl, isoamyl, isobutyl, isopropyl, ethyl, octyl, geranyl, cyclohexyl, citronellyl, terpenyl, linalyl, cinnamyl, phenyl ethyl, butyl, propyl, hexyl, benzyl, methyl, rhodinyl, etc.), isobutyric acid esters (isoamyl, geranyl, citronellyl, terpenyl, cinnamyl, octyl, nellyl, phenyl ethyl, phenyl propyl, phenoxyethyl, butyl, propyl, isopropyl, hexyl, benzyl, methyl, ethyl, linalyl, rhodinyl, etc.), undecylenic acid esters (allyl, isoamyl, butyl, ethyl, methyl, etc.), octanoic acid esters (allyl, isoamyl, ethyl, octyl, hexyl, butyl, methyl, linalyl, etc.), octenoic acid esters (methyl, ethyl, etc.), octyne carboxylic acid esters (methyl, ethyl, etc.), caproic acid esters (allyl, amyl, isoamyl, methyl, ethyl, isobutyl, propyl, hexyl, cis-3-hexenyl, trans-2-hexenyl, linalyl, geranyl, cyclohexyl, etc.), hexenoic acid esters (methyl, ethyl, etc.), valeric acid esters (amyl, isopropyl, isobutyl, ethyl, cis-3-hexenyl, trans-2-hexenyl, cinnamyl, phenyl ethyl, methyl, etc.), formic acid esters (anisyl, isoamyl, isopropyl, ethyl, octyl, geranyl, citronellyl, cinnamyl, cyclohexyl, terpinyl, phenyl ethyl, butyl, propyl, hexyl, cis-3-hexenyl, benzyl, linalyl, rhodinyl, etc.), crotonic acid esters (isobutyl, ethyl, cyclohexyl, etc.), cinnamic acid esters (allyl, ethyl, methyl, isopropyl, propyl, 3-phenyl propyl, benzyl, cyclohexyl, methyl, etc.), succinic acid esters (monomenthyl, diethyl, dimethyl, etc.), acetic acid esters (anisyl, amyl, α-amylcinnamyl, isoamyl, isobutyl, isopropyl, isopulegyl, isobornyl, isoeugenyl, eugenyl, 2-ethylbutyl, ethyl, 3-octyl, carbyl, dihydrocarbyl, p-cresyl, o-cresyl, geranyl, α- or β-santalyl, cyclohexyl, cyclonellyl, dihydrocuminyl, dimethyl benzylcarbinyl, cinnamyl, styralyl, decyl, dodecyl, terpinyl, guainyl, nellyl, nonyl, phenyl ethyl, phenyl propyl, butyl, furfuryl, propyl, hexyl, cis-3-hexenyl, trans-2-hexenyl, cis-3-nonenyl, cis-6-nonenyl, cis-3, cis-6-nonadienyl, 3-methyl-2-butenyl, menthyl, heptyl, benzyl, bornyl, myrcenyl, dihydromyrcenyl, myrtenyl, methyl, 2-methylbutyl, menthyl, linalyl, rhodinyl, etc.), salicylic acid esters (allyl, isoamyl, phenyl, phenyl ethyl, benzyl, ethyl, methyl, etc.), cyclohexylalkanoic acid esters (ethyl cyclohexyl acetate, allyl cyclohexyl propionate, allyl cyclohexyl butyrate, allyl cyclohexyl hexanoate, allyl cyclohexyl decanoate, allyl cyclohexyl valerate, etc.), stearic acid esters (ethyl, propyl, butyl, etc.), sebacic acid esters (diethyl, dimethyl, etc.), decanoic acid esters (isoamyl, ethyl, butyl, methyl, etc.), dodecanoic acid esters (isoamyl, ethyl, butyl, etc.), lactic acid esters (isoamyl, ethyl, butyl, etc.), nonanoic acid esters (ethyl, phenyl ethyl, methyl, etc.), nonenoic acid esters (allyl, ethyl, methyl, etc.), hydroxyhexanoic acid esters (ethyl, methyl, etc.), phenylacetic acid esters (isoamyl, isobutyl, ethyl, geranyl, citronellyl, cis-3-hexenyl, methyl, etc.), phenoxyacetic acid esters (allyl, ethyl, methyl, etc.), furancarboxylic acid esters (ethyl furancarboxylate, methyl furancarboxylate, hexyl furancarboxylate, isobutyl furanpropionate, etc.), propionic acid esters (anisyl, allyl, ethyl, amyl, isoamyl, propyl, butyl, isobutyl, isopropyl, benzyl, geranyl, cyclohexyl, citronellyl, cinnamyl, tetrahydrofurfuryl, tricyclodecenyl, heptyl, bornyl, methyl, menthyl, linalyl, terpinyl, α-methyl propionyl, β-methyl propionyl, etc.), heptanoic acid esters (allyl, ethyl, octyl, propyl, methyl, etc.), heptynecarboxylic acid esters (allyl, ethyl, propyl, methyl, etc.), myristic acid esters (isopropyl, ethyl, methyl, etc.), phenylglycidic acid esters (ethyl phenylglycidate, ethyl 3-methyl phenylglycidate, ethyl p-methyl-β-phenylglycidate, etc.), 2-methylbutyric acid esters (methyl, ethyl, octyl, phenyl ethyl, butyl, hexyl, benzyl, etc.), 3-methylbutyric acid esters (methyl, ethyl, etc.), butyric acid esters (anisyl, amyl, allyl, isoamyl, methyl, ethyl, propyl, octyl, guainyl, linalyl, geranyl, cyclohexyl, citronellyl, cinnamyl, nellyl, terpenyl, phenyl propyl, β-phenyl ethyl, butyl, hexyl, cis-3-hexenyl, trans-2-hexenyl, benzyl, rhodinyl, etc.), hydroxybutyric acid esters (methyl, ethyl or menthyl of 3-hydroxybutyrate, etc.) and the like can be used.

Examples of alcohols preferably include aliphatic alcohols (isoamyl alcohol, isopulegol, 2-ethylhexanol, 1-octanol, 3-octanol, 1-ecten-3-ol, 1-decanol, 1-dodecanol, 2,6-nonadienol, nonanol, 2-nonanol, cis-6-nonenol, trans-2, cis-6-nonadienol, cis-3, cis-6-nonadienol, butanol, hexanol, cis-3-hexenol, trans-2-hexenol, 1-undecanol, heptanol, 2-heptanol, 3-methyl-1-pentanol, etc.), terpene alcohols (carveol, borneol, isoborneol, carveol, piperitol, geraniol, α- or β-santalol, citronellol, 4-thujanol, terpineol, 4-terpineol, nellol, myrcenol, myrtenol, menthol, dihydromyrcenol, tetrahydromyrcenol, nerolidol, hydroxycitronellol, farnesol, perillyl alcohol, rhodinol, linalool, 1-menthol, etc.), and aromatic alcohols (anise alcohol, α-amylcinnamic alcohol, isopropyl benzylcarbinol, carvacrol, cuminic alcohol, dimethyl benzylcarbinol, cinnamic alcohol, phenylallyl alcohol, phenyl ethylcarbinol, β-phenyl ethyl alcohol, 3-phenyl propyl alcohol, benzyl alcohol, etc.).

Examples of aldehydes preferably include aliphatic aldehydes (octanal, nonanal, decanal, undecanal, 2,6-dimethyl-5-heptenal, 3,5,5-trimethylhexanal, cis-3, cis-6-nonadienal, trans-2, cis-6-nonadienal, valeraldehyde, propanal, isopropanal, hexanal, trans-2-hexenal, cis-3-hexenal, 2-pentenal, dodecanal, tetradecanal, trans-4-decenal, trans-2-tridecenal, trans-2-dodecenal, trans-2-undecenal, 2,4-hexadienal, cis-6-nonenal, trans-2-nonenal, 2-methylbutanal, etc.), aromatic aldehydes (anise aldehyde, α-amylcinnamic aldehyde, α-methylcinnamic aldehyde, cyclamen aldehyde, p-isopropyl phenyl acetaldehyde, ethyl vanillin, cuminic aldehyde, salicylaldehyde, cinnamic aldehyde, o-, m- or p-tolylaldehyde, vanillin, piperonal, phenyl acetaldehyde, heliotropine, benzaldehyde, 4-methyl-2-phenyl-2-pentenal, p-methoxycinnamic aldehyde, p-methoxybenzaldehyde, etc.), terpene aldehydes (geranial, citral, citronellal, α-sinensal, β-sinensal, perillyl aldehyde, hydroxycitronellal, tetrahydrocitral, myrtenal, cyclocitral, isocyclocitral, citronellyl oxyacetaldehyde, neral, α-methylene citronellal, myrac aldehyde, vernaldehyde, safranal, etc.).

Examples of ketones preferably include cyclic ketones (menthone, isomenthone, carvone, dihydrocarvone, pulegone, piperitone, 1-acetyl-3,3-dimethyl-1-cyclohexene, cis-jasmone, α-, β- or γ-irone, ethyl maltol, cyclotene, dihydronootkatone, 3,4-dimethyl-1,2-cyclopentadione, sotolon, α-, β-, γ- or δ-damascone, α-, β- or γ-damascenone, nootkatone, 2-sec-butylcyclohexanone, maltol, α-, β- or γ-ionone, α-, β- or γ-methylionone, α-, β- or γ-isomethylionone, furaneol, camphor, etc.), aromatic ketones (acetonaphthone, acetophenone, anisylidene acetone, raspberry ketone, p-methylacetophenone, anisyl acetone, p-methoxyacetophenone, etc.), linear ketones (diacetyl, 2-nonanone, diacetyl, 2-heptanone, 2,3-heptanedione, 2-pentanone, methyl amyl ketone, methyl nonyl ketone, β-methyl naphthyl ketone, methyl heptanone, 3-heptanone, 4-heptanone, 3-octanone, 2,3-hexanedione, 2-undecanone, dimethyl octenone, 6-methyl-5-heptyne-3-one, etc.).

Preferable examples of acetals include acetaldehyde diethyl acetal, acetaldehyde diamyl acetal, acetaldehyde dihexyl acetal, acetaldehyde propylene glycol acetal, acetaldehyde ethyl cis-3-hexenyl acetal, benzaldehyde glycerol acetal, benzaldehyde propylene glycol acetal, citral dimethyl acetal, citral diethyl acetal, citral propylene glycol acetal, citral ethylene glycol acetal, phenyl acetaldehyde dimethyl acetal, citronellyl methyl acetal, acetaldehyde phenyl ethyl propyl acetal, hexanal dimethyl acetal, hexanal dihexyl acetal, hexanal propylene glycol acetal, trans-2-hexenal diethyl acetal, trans-2-hexenal propylene glycol acetal, cis-3-hexenal diethyl acetal, heptanal diethyl acetal, heptanal ethylene glycol acetal, octanal dimethyl acetal, nonanal dimethyl acetal, decanal dimethyl acetal, decanal diethyl acetal, 2-methylundecanal dimethyl acetal, citronellal dimethyl acetal, Ambersage (manufactured by Givaudan), ethyl acetoacetate ethylene glycol acetal and 2-phenyl propanal dimethyl acetal.

Examples of phenols preferably include eugenol, isoeugenol, 2-methoxy-4-vinyl phenol, thymol, carvacrol, guaiacol and chavicol.

Preferable examples of ethers include anethole, 1,4-cineole, 1,8-cineole, dibenzyl ether, linalool oxide, limonene oxide, nellol oxide, rose oxide, methyl isoeugenol, methyl chavicol, isoamyl phenyl ethyl ether, β-naphthyl methyl ether, phenyl propyl ether, p-cresyl methyl ether, vanillyl butyl ether, α-terpinyl methyl ether, citronellyl ethyl ether, geranyl ethyl ether, rose furan, theaspirane, decyl methyl ether and methyl phenyl methyl ether.

Preferable examples of lactones include γ- or δ-decalactone, γ-heptalactone, γ-nonalactone, γ- or δ-hexalactone, γ- or δ-octalactone, γ- or δ-undecalactone, δ-dodecalactone, δ-2-decenolactone, methyllactone, 5-hydroxy-8-undecenoic acid δ-lactone, jasmine lactone, menthalactone, dihydrocoumarin, octahydrocoumarin and 6-methylcoumarin.

Preferable examples of furans include furan, 2-methylfuran, 3-methylfuran, 2-ethylfuran, 2,5-diethyltetrahydrofuran, 3-hydroxy-2-methyltetrahydrofuran, 2-(methoxymethyl)furan, 2,3-dihydrofuran, menthofuran, furfural, 5-methylfurfural, 3-(2-furyl)-2-methyl-2-propenal, 5-(hydroxymethyl)furfural, 2,5-dimethyl-4-hydroxy-3(2H)-furanone (furaneol), 4,5-dimethyl-3-hydroxy-2(5H)-furanone (sotolon), 2-ethyl-4-hydroxy-5-methyl-3(2H)-furanone (homofuraneol), 5-ethyl-3-hydroxy-4-methyl-2(5H)furanone (homosotolon), 3-methyl-1,2-cyclopentanedione (cyclotene), 2(5H)-furanone, 4-methyl-2(5H)-furanone, 5-methyl-2(5H)-furanone, 2-methyl-3(2H)-furanone, 5-methyl-3(2H)-furanone, 2-acetylfuranone, 2-acetyl-5-methylfuran, furfuryl alcohol, methyl 2-furancarboxylate, ethyl 2-furancarboxylate and furfuryl acetate.

Preferable examples of hydrocarbons include α- or β-bisabolene, β-caryophyllene, p-cymene, terpinene, terpinolene, cadinene, farnesene, limonene, ocimene, myrcene, α- or β-pinene, 1,3,5-undecatriene and valencene.

Examples of acids preferably include octanoic acid, nonanoic acid, decanoic acid, 2-decenoic acid, geranic acid, dodecanoic acid, myristic acid, stearic acid, lactic acid, phenylacetic acid, pyruvic acid, trans-2-methyl-2-pentenoic acid, 2-methyl-cis-3-pentenoic acid, 2-methyl-4-pentenoic acid and cyclohexane carboxylic acid.

Furthermore, examples of natural flavors include anise, orange, lemon, lime, mandarin, petitgrain, bergamot, lemon balm, grapefruit, elemi, olibanum, lemongrass, neroli, marjoram, angelica root, star anise, basil, bay, calamus, camomile, caraway, cardamon, cassia, cinnamon, peppermint, spearmint, mint, pennyroyal, pepper, perilla, cypress, oregano, cascarilla, ginger, parsley, pine needle, sage, hyssop, ti-tree, mustard, horse radish, clary sage, clove, cognac, coriander, estragon, eucalyptus, fennel, guaiac wood, dill, cajuput, wormseed, pimento, juniper, fenugreek, garlic, laurel, mace, myrrh, nutmeg, spruce, geranium, citronella, lavender, lavandin, palmarosa, rose, rosemary, sandalwood, oakmoss, cedarwood, vetiver, linaloe, bois de rose, patchouli, labdanum, cumin, thyme, ylang ylang, birch, capsicum, celery, Tolu balsam, genet, immortelle, benzoin, jasmine, cassie, tuberose, reseda, marigold, mimosa, opoponax, orris, vanilla and licorice. Flavor components contained in such natural flavors can also be used.

While any (a) oil-soluble component can be used as long as it contains a flavor, it may also contain other oil-soluble component in addition to the flavor. As an oil-soluble component other than the flavor, those generally used for food or beverages can be used, where examples include: various vegetable and animal fats and oils such as palm oil, coconut oil, corn oil, rapeseed oil, beef tallow, lard and milk fat; oil-soluble natural pigments such as medium-chain fatty acid triglycerides with a carbon number of 8-12, β-carotene, paprika pigment, annatto pigment and chlorophyll; fat-soluble vitamins such as vitamin A, vitamin D and vitamin E; antioxidants; and plant resins such as rosin, copal, dammar, elemi and ester gum.

The blending amount of the flavor contained in an emulsified flavor composition can appropriately be adjusted depending on the intensity of the aroma of the flavor, but it is usually 0.1-10% by weight and preferably 0.1-5% by weight.

(b) Polyglycerol Fatty Acid Ester

An emulsified flavor composition for alcoholic beverages of the present invention comprises (b) a polyglycerol fatty acid ester whose 1% by weight aqueous solution has transmittance of 65% or higher at 600 nm. A polyglycerol fatty acid ester is obtained by esterification of fatty acids to one or more hydroxyl groups of polyglycerol derived by polymerization of glycerol, where there are various types of polyglycerol fatty acid esters depending on the degree of polymerization of the glycerol, the number of the fatty acids (esterification degree) and the type of the fatty acids. Among them, a polyglycerol fatty acid ester whose 1% by weight aqueous solution has transmittance of 65% or higher at 600 nm is used with the present invention. The polyglycerol fatty acid ester having the above-described transmittance is capable of maintaining a stable emulsified state even when an emulsified flavor composition for alcoholic beverages of the present invention is mixed with a concentrated syrup containing a high-concentration alcohol. The above-described transmittance of the polyglycerol fatty acid ester is 65% or higher, and preferably 70%-100%.

According to the present invention, a polyglycerol configuring the polyglycerol fatty acid ester preferably has an average degree of polymerization of 6-10, and more preferably it is decaglycerol with an average degree of polymerization of 10.

A fatty acid configuring the polyglycerol fatty acid ester preferably has a carbon number of 14-18, and more preferably it is stearic acid, oleic acid or a combination thereof.

Moreover, in regard to the esterification degree of the polyglycerol fatty acid ester, a polyglycerol fatty acid ester in which 0.1-2 mol of fatty acids are esterified with respect to 1 mol of polyglycerol is preferable, and a polyglycerol mono-fatty acid ester in which 1 mol of fatty acids are esterified is more preferable.

Examples of a polyglycerol fatty acid ester particularly preferably used with the present invention include decaglycerol monostearic acid ester, decaglycerol monooleic acid ester or a combination thereof.

Various types of polyglycerol fatty acid esters are commercially available. Among them, examples of a polyglycerol fatty acid ester whose 1% by weight aqueous solution has transmittance of 65% or higher at 600 nm that is preferably used with the present invention include Decaglyn 1-SVEX (trade name, manufactured by Nikko Chemicals Co., Ltd.) and Decaglyn 1-OVEX (trade name, manufactured by Nikko Chemicals Co., Ltd.).

According to the present invention, transmittance of a polyglycerol fatty acid ester is measured as follows. First, a polyglycerol fatty acid ester is dispersed in ion-exchange water to 1% by weight, and the resultant is agitated for 30 minutes while heating in a hot-water bath at 80° C., thereby obtaining a homogeneous aqueous solution. Subsequently, the resulting aqueous polyglycerol fatty acid ester solution is cooled to 25° C. to be used as a test solution. Transmittance of this test solution at 600 nm is measured by using a cell with an optical path length of 1 cm and water as a control solution. Transmittance is measured by using a general spectrophotometer. When two or more types of polyglycerol fatty acid esters are to be used, they are mixed at their used weight ratio and prepared to give 1% by weight as a polyglycerol fatty acid ester for measurement.

If the blending amount of the polyglycerol fatty acid ester in an emulsified flavor composition is too large with respect to the oil-soluble component, sediments and floating matters are likely to be caused upon dispersion in a concentrated syrup with a high-alcohol concentration. If the blending amount is too small, turbidity may become too high at the drinking concentration. Therefore, the blending amount of the polyglycerol fatty acid ester in the emulsified flavor composition is preferably 1-200 parts by weight, more preferably 5-150 parts by weight and still more preferably 5-120 parts by weight to 100 parts by weight of (a) the oil-soluble component containing a flavor.

(c) Lecithin

The emulsified flavor composition for alcoholic beverages of the present invention further comprises (c) lecithin. The (c) lecithin used with the present invention is not particularly limited as long as it is generally used for food or a beverage, where examples thereof include soybean lecithin, rapeseed lecithin, sunflower lecithin, egg-yolk lecithin and enzymatically modified lecithin. Among them, since enzymatically modified lecithin may ruin the taste of the product and bring out bitterness when added at an increased amount, it is favorable to use lecithin that is not enzymatically modified. In particular, soybean lecithin, rapeseed lecithin and sunflower lecithin that are not enzymatically modified are preferable. Examples of such lecithin preferably include Nisshin Lecithin DX (trade name, manufactured by Nisshin OilliO Group) (soybean lecithin), and GIRALEC Premium (trade name, manufactured by Lasenor) (sunflower lecithin). According to a preferable embodiment of the present invention, the emulsified flavor composition for alcoholic beverages of the present invention is substantially free of enzymatically modified lecithin. For example, the blending amount of the enzymatically modified lecithin in the emulsified composition is preferably less than 0.1% by weight with respect to the total weight of the emulsified flavor composition.

If the blending amount of the lecithin in an emulsified flavor composition is too small with respect to the polyglycerol fatty acid ester, sediments and floating matters are likely to be caused upon dispersion in a concentrated syrup with a high-alcohol concentration. If the blending amount is too large, the turbidity may become too high at the drinking concentration. Therefore, the blending amount of the lecithin in the emulsified composition is preferably 5-200 parts by weight, more preferably 10-150 parts by weight and still more preferably 20-135 parts by weight to 100 parts by weight of (b) the polyglycerol fatty acid ester.

Moreover, if the blending amount of the lecithin in an emulsified flavor composition is too small with respect to the oil-soluble component, sediments and floating matters are likely to be caused upon dispersion in a concentrated syrup with a high-alcohol concentration. If the blending amount is too large, the turbidity may become too high at the drinking concentration. Therefore, the blending amount of the lecithin in the emulsified composition is preferably 1-150 parts by weight, more preferably 5-80 parts by weight and still more preferably 8-80 parts by weight with respect to 100 parts by weight of (a) the oil-soluble component.

In the emulsified flavor composition for alcoholic beverages of the present invention, the blending amount of (a) the oil-soluble component, (b) the polyglycerol fatty acid ester and (c) the lecithin is preferably 0.1-45% by weight, more preferably 0.1-22.5% by weight and still more preferably 0.1-15% by weight with respect to the total weight of the emulsified flavor composition.

(d) Water-Soluble Solvent

An emulsified flavor composition for alcoholic beverages of the present invention comprises (d) a water-soluble solvent in addition to (a) the oil-soluble component, (b) the polyglycerol fatty acid ester and (c) the lecithin. Examples of (d) the water-soluble solvent used with the present invention include water and polyhydric alcohols.

The polyhydric alcohol is not particularly limited as long as it is generally used for food or a beverage, where examples thereof include glycerol, propylene glycol, 1,3-butylene glycol, D-sorbitol and the like. Glycerol is preferable among them.

The blending amount of the water-soluble solvent in an emulsified flavor composition is not particularly limited and may suitably be determined in order to adjust the concentration of the oil-soluble component and the like.

Beside the above-described components, an emulsified flavor composition for alcoholic beverages of the present invention may additionally comprise a water-soluble flavor, a water-soluble pigment such as a caramel pigment, a saccharide such as a thickening polysaccharide and a fructose-glucose syrup, dietary fiber such as pectin and a high-sweetness sweetener such as aspartame, within a range that does not impair the effect of the present invention.

The emulsified flavor composition for alcoholic beverages of the present invention can be produced by employing a known technique used for preparation of an emulsified preparation. Specifically, an example of such technique includes a method in which an agitation device such as a homogenizing mixer or a high-pressure homogenizer is used to agitate and mix an oil-soluble component and a water-soluble component. Optionally, cooling or warming can be performed during agitation and mixing.

By using the emulsified flavor composition for alcoholic beverages of the present invention, the oil-soluble flavor can transparently be dispersed in an alcoholic beverage. Herein, an “alcoholic beverage” refers to a beverage composition with an alcohol concentration of 1% or higher by volume. The beverage composition may be a concentrated syrup for alcoholic beverages, which may suitably be diluted later to prepare an alcoholic beverage with a desired alcohol concentration.

The alcohol concentration of an alcoholic beverage according to the present invention is preferably 1-80% by volume, more preferably 1-60% by volume, and still more preferably 1-50% by volume. The alcohol concentration is particularly less than 10% by volume, and thus 1-10% by volume is preferable.

While the alcohol concentration of a concentrated syrup for alcoholic beverages is not particularly limited as long as it is suitably determined considering the purpose of use and the like, in general, it is preferably 20% or higher by volume, more preferably 20-60% by volume, and still more preferably 20-50% by volume.

Examples of an alcoholic beverage obtained by adding the emulsified flavor composition for alcoholic beverages of the present invention include sours, shochu (Japanese distilled alcohol)-based beverages, cocktails, sweetened fruit wine, other miscellaneous liquors and liqueurs. According to the present invention, the alcoholic beverage may be carbonated or contain fruit juice.

While the additive amount of the emulsified flavor composition for alcoholic beverages of the present invention is not particularly limited and can suitably be determined considering the purpose of use and the like, in general, it is preferably 0.01-0.5% by weight and more preferably 0.03-0.2% by weight with respect to the total amount of the resulting alcoholic beverage.

According to the present invention, the emulsified flavor composition for alcoholic beverages of the present invention may be added directly to an alcoholic beverage or it may be added to a concentrated syrup for alcoholic beverages (which is a concentrate of an alcoholic beverage) during the steps for producing the alcoholic beverage. According to a preferable embodiment of the present invention, an emulsified flavor composition for alcoholic beverages of the present invention does not generate a floating matter or a sediment and is capable of maintaining a stable emulsified state, even when it is mixed with a concentrated syrup with such a high-alcohol concentration.

When an emulsified composition for alcoholic beverages of the present invention is added to an alcohol concentrated syrup, the resulting syrup solution can be diluted in a water-soluble solvent such as water or carbonated water to prepare a desired alcoholic beverage.

### EXAMPLES

Hereinafter, the present invention will be described in more detail by way of examples, although the present invention should not be limited in any way to these examples. Herein, the transmittance of polyglycerol fatty acid ester was determined according to the following method.

<Determination of Transmittance of Polyglycerol Fatty Acid Ester>

First, polyglycerol fatty acid ester was dispersed in ion-exchange water to 1% by weight, and the resultant was agitated for 30 minutes while heating in a hot-water bath at 80° C., thereby obtaining a homogeneous aqueous solution. Subsequently, the resulting aqueous polyglycerol fatty acid ester solution was cooled to 25° C. to be used as a test solution. Transmittance of this test solution at 600 nm was measured by using a cell with an optical path length of 1 cm and water as a control solution. Transmittance was measured using UV-VIS spectrophotometer UV-1700, manufactured by Shimadzu Corporation. When two or more types of polyglycerol fatty acid esters were to be used, they were mixed at their used weight ratio and prepared to give 1% by weight as the polyglycerol fatty acid ester for measurement.

### Example 1

7.5 g of a polyglycerol fatty acid ester (trade name: Decaglyn 1-SVEX, manufactured by Nikko Chemicals Co., Ltd., decaglycerol monostearic acid ester, HLB: 12.5) whose 1% by weight aqueous solution had transmittance of 85.5% at 600 nm was dissolved in 219.6 g of glycerol (trade name: REFINED GLYCEROL, Kao Corporation) and 62.4 g of water, while warming. While agitating the resulting solution with a high-speed agitator (homogenizing mixer MARK II, manufactured by PRIMIX Corporation), a homogeneous mixture of 7.5 g of a lemon-lime flavor (manufactured by Takasago International Corporation) and 3 g of soybean lecithin (trade name: Nisshin Lecithin DX, manufactured by Nisshin OilliO Group) was further added and the resultant was subjected to an emulsification treatment at 9000 rpm for 10 minutes to prepare an emulsified flavor composition.

### Example 2

An emulsified flavor composition was prepared in the same manner as Example 1 except the polyglycerol fatty acid ester was replaced with Decaglyn 1-OVEX (trade name, manufactured by Nikko Chemicals Co., Ltd., decaglycerol monooleic acid ester, HLB: 12.0) whose 1% by weight aqueous solution had transmittance of 73.5% at 600 nm.

### Example 3

An emulsified flavor composition was prepared in the same manner as Example 1 except the blending amounts of water and soybean lecithin were altered as indicated in Table 1.

### Example 4

An emulsified flavor composition was prepared in the same manner as Example 1 except the blending amounts of water and soybean lecithin were altered as indicated in Table 1.

### Example 5

An emulsified flavor composition was prepared in the same manner as Example 1 except the blending amounts of the polyglycerol fatty acid ester and water were altered as indicated in Table 1.

### Comparative Example 1

7.5 g of a polyglycerol fatty acid ester (trade name: Decaglyn 1-SVEX, manufactured by Nikko Chemicals Co., Ltd., decaglycerol monostearic acid ester, HLB: 12.5) whose 1% by weight aqueous solution had transmittance of 85.5% at 600 nm was dissolved in 219.6 g of glycerol (trade name: REFINED GLYCEROL, Kao Corporation) and 65.4 g of water while warming. While agitating the resulting solution with a high-speed agitator (homogenizing mixer MARK II, manufactured by PRIMIX Corporation), 7.5 g of a lemon-lime flavor (manufactured by Takasago International Corporation) was further added and the resultant was subjected to an emulsification treatment at 9000 rpm for 10 minutes to prepare an emulsified flavor composition.

### Comparative Example 2

An emulsified flavor composition was prepared in the same manner as Example 1 except the polyglycerol fatty acid ester was replaced with Decaglyn 1-SVF (trade name, manufactured by Nikko Chemicals Co., Ltd., decaglycerol monostearic acid ester, HLB: 12.0) whose 1% by weight aqueous solution had transmittance of 60.2% at 600 nm.

### Comparative Example 3

An emulsified flavor composition was prepared in the same manner as Example 1 except the polyglycerol fatty acid ester was replaced with POEM J-0381V (trade name, manufactured by Riken Vitamin Co., Ltd., decaglycerol monooleic acid ester, HLB: 14.0) whose 1% by weight aqueous solution had transmittance of 39.2% at 600 nm.

The compositions (% by weight) of the emulsified flavor compositions of Examples 1-5 and Comparative examples 1-3 are shown in Table 1.

TABLE 1

| | | | Trans- | Exam- | Exam- | Exam- | Exam- | Exam- | Comparative | Comparative | Comparative |
|---|---|---|---|---|---|---|---|---|---|---|---|
| | | HLB | mittance* | ple 1 | ple 2 | ple 3 | ple 4 | ple 5 | example 1 | example 2 | example 3 |
| Lemon-lime flavor | | | | 2.5 | 2.5 | 2.5 | 2.5 | 2.5 | 2.5 | 2.5 | 2.5 |
| Polyglycerol | Decaglyn 1-SVEX | 12.5 | 85.5% | 2.5 | — | 2.5 | 2.5 | 3.0 | 2.5 | — | — |
| fatty acid | Decaglyn 1-SVF | 12.0 | 60.2% | — | — | — | — | — | — | 2.5 | — |
| ester | Decaglyn 1-OVEX | 12.0 | 73.5% | — | 2.5 | — | — | — | — | — | — |
| | POEM J-0381 | 14.0 | 39.2% | — | — | — | — | — | — | — | 2.5 |

| | | | | | | | | |
|---|---|---|---|---|---|---|---|---|
| Soybean lecithin | 1.0 | 1.0 | 0.5 | 2.0 | 1.0 | — | 1.0 | 1.0 |
| Glycerol | 73.2 | 73.2 | 73.2 | 73.2 | 73.2 | 73.2 | 73.2 | 73.2 |
| Water | 20.8 | 20.8 | 21.3 | 19.8 | 20.3 | 21.8 | 20.8 | 20.8 |
| Total | 100.0 | 100.0 | 100.0 | 100.0 | 100.0 | 100.0 | 100.0 | 100.0 |
| Part by weight of polyglycerol fatty acid ester | 100 | 100 | 100 | 100 | 120 | 100 | 100 | 100 |
| to 100 parts by weight of oil-soluble content | | | | | | | | |
| Part by weight of lecithin to 100 parts by | 40 | 40 | 20 | 80 | 33 | 0 | 40 | 40 |
| weight of polyglycerol fatty acid ester | | | | | | | | |
| Part by weight of lecithin to 100 parts by | 40 | 40 | 20 | 80 | 40 | 0 | 40 | 40 |
| weight of oil-soluble content | | | | | | | | |

*Transmittance of 1% by weight aqueous solution of polyglycerol fatty acid ester at 600 nm

### [Test Example 1] Stability of Emulsified States

[1] Preparation of Five-Times Concentrated Syrup

Water was added to 368 ml of 95% ethanol, 230 g of fructose-glucose syrup, 18 g of citric acid and 4 g of sodium citrate to make a 1000 ml solution, thereby preparing a five-times concentrated syrup of an alcoholic beverage (alcohol concentration: 35% by volume). To this five-times concentrated syrup, 0.5% by weight of each of the emulsified flavor compositions prepared in Example 1 and Comparative examples 1 and 2 was added.

[2] Evaluation Method

Five-times concentrated syrups added with the emulsified flavor compositions of Examples 1-5 and Comparative examples 1-3, respectively, were stored for a week at room temperature to observe the state of the syrups. The evaluation results are shown in Table 2.

TABLE 2

| | Visual observation |
|---|---|
| Example 1 | Homogeneous, slightly turbid |
| Example 2 | Homogeneous, slightly turbid |
| Example 3 | Homogeneous, slightly turbid |
| Example 4 | Homogeneous, slightly turbid |
| Example 5 | Homogeneous, slightly turbid |
| Comparative | Non-homogeneous, presence of white linear |
| example 1 | floating matter |
| Comparative | Non-homogeneous, presence of white linear |
| example 2 | floating matter |
| Comparative | Non-homogeneous, presence of white linear |
| example 3 | floating matter |

The emulsified flavor compositions of Examples 1-5 that were added to five-times concentrated syrups were homogeneous and showed good emulsion stability even after a week. On the other hand, the emulsified flavor compositions of Comparative examples 1-3 that were added to five-times concentrated syrups generated white linear floating matters and showed non-homogeneous states after a week.

### [Test Example 2] Evaluation of Transparency when Diluted to Drinking Concentration

The five-times concentrated syrups (Examples 1, 2, 3, 4 and 5) that were subjected to one-week evaluation in Test example 1 were diluted 5 times with water to prepare alcoholic beverages. Subsequently, transparency of them was evaluated by visual observation and transmittance measurement. The results are shown in Table 3.

TABLE 3

| | Visual observation | Transmittance |
|---|---|---|
| Example 1 | Homogeneous, transparent | 96.4% |
| Example 2 | Homogeneous, transparent | 96.3% |
| Example 3 | Homogeneous, transparent | 98.2% |
| Example 4 | Homogeneous, transparent | 95.3% |
| Example 5 | Homogeneous, transparent | 95.1% |

Even when the emulsified flavor compositions prepared in Examples 1-5 were added to five-times concentrated syrups, stored at room temperature for a week and diluted 5 times with water, they gave homogeneous alcoholic beverages with transparent appearance.

### Example 6

13.5 g of a polyglycerol fatty acid ester (trade name: Decaglyn 1-SVEX, manufactured by Nikko Chemicals Co., Ltd., decaglycerol monostearic acid ester, HLB: 12.5) whose 1% by weight aqueous solution had transmittance of 85.5% at 600 nm was dissolved in 212.1 g of glycerol (trade name: REFINED GLYCEROL, Kao Corporation) and 53.1 g of water while warming. While agitating the resulting solution with a high-speed agitator (homogenizing mixer MARK II, manufactured by PRIMIX Corporation), a homogeneous mixture of 15 g of a lemon flavor (manufactured by Takasago International Corporation), 6 g of soybean lecithin (trade name: Nisshin Lecithin DX, manufactured by Nisshin OilliO Group) and 0.3 g of vitamin E (manufactured by Eisai Co., Ltd.) was added and the resultant was subjected to an emulsification treatment at 9000 rpm for 20 minutes to prepare an emulsified flavor composition.

### Example 7

15 g of a polyglycerol fatty acid ester (trade name: RYOTO polyglyester M-7D, manufactured by Mitsubishi-Kagaku Foods Corporation, decaglycerol monomyristic acid ester, HLB: 16) whose 1% by weight aqueous solution had transmittance of 99.2% at 600 nm and 6 g of a sucrose fatty acid ester (trade name: DK ESTER SS, manufactured by DKS Co. Ltd.) were dissolved in 231 g of glycerol (trade name: REFINED GLYCEROL, Kao Corporation) and 29.7 g of water while warming. While agitating the resulting solution with a high-speed agitator (homogenizing mixer MARK II, manufactured by PRIMIX Corporation), a homogeneous mixture of 15 g of a lemon flavor (manufactured by Takasago International Corporation), 3 g of enzymatically modified lecithin (trade name: Emultop, manufactured by Cargill, Incorporated) and 0.3 g of vitamin E (manufactured by Eisai Co., Ltd.) was added and the resultant was subjected to an emulsification treatment at 9000 rpm for 20 minutes to prepare an emulsified flavor composition.

### Comparative Example 4

Three types of polyglycerol fatty acid esters, specifically, 15 g of Decaglyn 1-M (trade name, manufactured by Nikko Chemicals Co., Ltd., decaglycerol monomyristic acid ester, HLB: 14), 3 g of Decaglyn 1-OV (trade name, manufactured by Nikko Chemicals Co., Ltd., decaglycerol monooleic acid ester, HLB: 12.0) and 0.3 g of RYOTO polyglyester O-50D (trade name, manufactured by Mitsubishi-Kagaku Foods Corporation, decaglycerol oleate, HLB: 7), were used and dissolved in 210 g of glycerol (trade name: REFINED GLYCEROL, Kao Corporation) and 55.2 g of water while warming. While agitating the resulting solution with a high-speed agitator, a homogeneous mixture of 15 g of a lemon flavor (manufactured by Takasago International Corporation), 0.6 g of enzymatically modified lecithin (trade name: Emultop, manufactured by Cargill, Incorporated), 0.3 g of vitamin E (manufactured by Eisai Co., Ltd.) and 0.6 g of medium-chain fatty acid triglyceride (trade name: SUKORE, manufactured by Nisshin OilliO Group) was added and the resultant was subjected to an emulsification treatment at 9000 rpm for 20 minutes with a high-speed agitator (homogenizing mixer MARK II, manufactured by PRIMIX Corporation) to prepare an emulsified flavor composition.

Here, transmittance of a 1% by weight aqueous solution of the three types of polyglycerol fatty acid esters at the above-described blending ratio was 55.8% at 600 nm.

### Comparative Example 5

13.5 g of a polyglycerol fatty acid ester (trade name: Decaglyn 1-SVF, manufactured by Nikko Chemicals Co., Ltd., decaglycerol monostearic acid ester, HLB: 12.0) whose 1% by weight aqueous solution had transmittance of 60.2% at 600 nm and 3 g of a sucrose fatty acid ester (trade name: DK ESTER SS, manufactured by DKS Co. Ltd.) were dissolved in 237.3 g of glycerol (trade name: REFINED GLYCEROL, Kao Corporation) and 29.7 g of water while warming. While agitating the resulting solution with a high-speed agitator (homogenizing mixer MARK II, manufactured by PRIMIX Corporation), a homogeneous mixture of 15 g of a lemon flavor (manufactured by Takasago International Corporation), 1.2 g of enzymatically modified lecithin (trade name: Emultop, manufactured by Cargill, Incorporated) and 0.3 g of vitamin E (manufactured by Eisai Co., Ltd.) was added and the resultant was subjected to an emulsification treatment at 9000 rpm for 20 minutes to prepare an emulsified flavor composition.

The compositions (% by weight) of the emulsified flavor compositions of Examples 6 and 7, and Comparative examples 4 and 5 are shown in Table 4.

TABLE 4

| | | | Trans- | | | Comparative | Comparative |
|---|---|---|---|---|---|---|---|
| | | HLB | mittance* | Example 6 | Example 7 | example 4 | example 5 |
| Lemon flavor | | | | 5.0 | 5.0 | 5.0 | 5.0 |
| Medium-chain fatty acid triglyceride | | | | — | — | 0.2 | — |
| Vitamin E | | | | 0.1 | 0.1 | 0.1 | 0.1 |
| Polyglycerol | Decaglyn 1-SVEX | 12.5 | 85.5% | 4.5 | — | — | — |
| fatty acid | RYOTO polyglyester M-7D | 16.0 | 99.2% | — | 5.0 | — | — |
| ester | Decaglyn 1-OV | 12.0 | 55.8% | — | — | 1.0 | — |
| | Decaglyn 1-M | 14.0 | | — | — | 5.0 | — |
| | RYOTO polyglyester O-50D | 7.0 | | — | — | 0.1 | — |
| | Decaglyn 1-SVF | 12.0 | 60.2% | — | — | — | 4.5 |

| | | | | |
|---|---|---|---|---|
| Soybean lecithin | 2.0 | — | — | — |
| Enzymatically modified lecithin | — | 1.0 | 0.2 | 0.4 |
| Sucrose fatty acid ester | — | 2.0 | — | 1.0 |
| Glycerol | 70.7 | 77.0 | 70.0 | 79.1 |
| Water | 17.7 | 9.9 | 18.4 | 9.9 |
| Total | 100.0 | 100.0 | 100.0 | 100.0 |
| Part by weight of polyglycerol fatty acid ester | 88 | 98 | 115 | 88 |
| to 100 parts by weight of oil-soluble content | | | | |
| Part by weight of lecithin to 100 parts by | 44 | 20 | 3.3 | 8.9 |
| weight of polyglycerol fatty acid ester | | | | |
| Part by weight of lecithin to 100 parts by | 39 | 20 | 3.8 | 7.8 |
| weight of oil-soluble content | | | | |

*Transmittance of 1% by weight aqueous solution of polyglycerol fatty acid ester at 600 nm

### [Test Example 3] Stability of Emulsified State

The stability of the emulsified states was evaluated in the same manner as Test example 1 using the emulsified flavor compositions of Examples 6 and 7, and Comparative examples 4 and 5. The evaluation results are shown in Table 5.

TABLE 5

| | Visual observation |
|---|---|
| Example 6 | Homogeneous, slightly turbid |
| Example 7 | Homogeneous, slightly turbid |
| Comparative | Non-homogeneous, oil float |
| example 4 | |
| Comparative | Non-homogeneous, presence of white linear floating |
| example 5 | matter |

The emulsified flavor compositions of Examples 6 and 7 that were added to five-times concentrated syrups were homogeneous and showed good emulsion stability even after a week. On the other hand, the emulsified flavor composition of Comparative example 4 that was added to five-times concentrated syrup had oil floating on the syrup and showed a non-homogeneous state after a week. Moreover, the emulsified flavor composition of Comparative example 5 that was added to five-times concentrated syrup generated white linear floating matters and showed a non-homogeneous state after a week.

### [Test Example 4] Evaluation of Transparency when Diluted to Drinking Concentration

The five-times concentrated syrups (Examples 6 and 7) that were subjected to one-week evaluation in Test example 3 were diluted 5 times with water to prepare alcoholic beverages. Subsequently, transparency of them was evaluated by visual observation and transmittance measurement. The results are shown in Table 6.

TABLE 6

| | Visual | |
|---|---|---|
| | observation | Transmittance |
| Example 6 | Homogeneous, | 95.3% |
| | transparent | |
| Example 7 | homogeneous, | 93.4% |
| | slightly turbid | |

Even when the emulsified flavor composition prepared in Example 6 was added to a five-times concentrated syrup, stored at room temperature for a week and diluted 5 times with water, it was capable of making a homogeneous alcoholic beverage with transparent appearance. Meanwhile, when the emulsified flavor composition prepared in Example 7 was added to a five-times concentrated syrup, stored at room temperature for a week and diluted 5 times with water, it made an alcoholic beverage that was homogeneous but with slightly turbid appearance.

### [Test Example 5] Evaluation of Taste/Flavor of Alcoholic Beverage Added with Emulsified Flavor Composition

Water was added to 140 ml of vodka with an alcohol content of 50%, 3.6 g of citric acid, 0.8 g of sodium citrate, 0.1 g of vitamin C, 0.13 g of acesulfame potassium and 0.016 g of sucralose to make a 1000 ml solution, thereby preparing an alcoholic beverage with an alcohol content of 7%. 0.1% by weight of each of the emulsified flavor compositions prepared in Example 6 and 7, and Comparative example 4 was added to prepare alcoholic beverages containing the respective emulsified flavor compositions.

These alcoholic beverages were used to carry out sensory evaluation.

<Method>

Evaluation was carried out by eight in-house specialized panelists by five-grade evaluation where “1” represented the weakest bitterness and “5” represented the strongest bitterness. Average values of the evaluation results from the eight panelists are summarized in Table 7.

TABLE 7

| | Bitterness |
|---|---|
| Example 6 | 1.8 |
| Example 7 | 3.8 |
| Comparative example 4 | 3.9 |

The alcoholic beverages containing the emulsified flavor compositions prepared in Example 7 and Comparative example 4 had strong bitterness where the taste/flavor of the alcoholic beverages were impaired, whereas the alcoholic beverage containing the emulsified flavor composition prepared in Example 6 had weak bitterness where the taste/flavor of the alcoholic beverage was not impaired.

### Example 8

0.9 g of a polyglycerol fatty acid ester (trade name: Decaglyn 1-SVEX, manufactured by Nikko Chemicals Co., Ltd., decaglycerol monostearic acid ester, HLB: 12.5) whose 1% by weight aqueous solution had transmittance of 85.5% at 600 nm was dissolved in 244.2 g of glycerol (trade name: REFINED GLYCEROL, Kao Corporation) and 42.9 g of water while warming. While agitating the resulting solution with a high-speed agitator (homogenizing mixer MARK II, manufactured by PRIMIX Corporation), a homogeneous mixture of 10.8 g of a Japanese plum flavor containing 0.9 g of medium-chain fatty acid triglyceride (manufactured by Takasago International Corporation), 0.9 g of sunflower lecithin (trade name: GIRALEC Premium, manufactured by Lasenor) and 0.3 g of extracted tocopherol (trade name: Riken E-Oil Super 80N/manufactured by Riken Vitamin Co., Ltd.) was added and the resultant was subjected to an emulsification treatment at 9000 rpm for 10 minutes to prepare an emulsified flavor composition. The composition (% by weight) of the emulsified flavor composition of Example 8 is shown in Table 8.

TABLE 8

| | | HLB | Transmittance* | Example 8 |
|---|---|---|---|---|
| Japanese plum flavor | | | | 3.6 |
| Extracted tocopherol | | | | 0.1 |
| Polyglycerol fatty | Decaglyn 1-SVEX | 12.5 | 85.5% | 0.3 |
| acid ester | | | | |

| | |
|---|---|
| Sunflower lecithin | 0.3 |
| Glycerol | 81.4 |
| Water | 14.3 |
| Total | 100.0 |
| Part by weight of polyglycerol fatty acid ester to 100 parts by | 8 |
| weight of oil-soluble content | |
| Part by weight of lecithin to 100 parts by weight of | 100 |
| polyglycerol fatty acid ester | |
| Part by weight of lecithin to 100 parts by weight of | 8 |
| oil-soluble content | |

*Transmittance of 1% by weight aqueous solution of polyglycerol fatty acid ester at 600 nm

### [Test Example 6] Stability of Emulsified State

The emulsified flavor composition of Example 8 was used to evaluate the stability of the emulsified state in the same manner as Test example 1. It was homogeneous and showed good emulsion stability even a week after being added to a five-times concentrated syrup.

### [Test Example 7] Evaluation of Transparency when Diluted to Drinking Concentration

The five-times concentrated syrup (Example 8) that was subjected to one-week evaluation in Test example 6 was further diluted 5 times with water to prepare an alcoholic beverage. Subsequently, transparency of the resultant was evaluated by visual observation and transmittance measurement, where it had transparent appearance and transmittance of 95.5%. Even when the emulsified flavor composition prepared in Example 8 was added to a five-times concentrated syrup, stored at room temperature for a week and diluted 5 times with water, it gave a homogeneous alcoholic beverages with transparent appearance.

### Example 9

1.8 g of a polyglycerol fatty acid ester (trade name: Decaglyn 1-SVEX, manufactured by Nikko Chemicals Co., Ltd., decaglycerol monostearic acid ester, HLB: 12.5) whose 1% by weight aqueous solution had transmittance of 85.5% at 600 nm was dissolved in 231.6 g of glycerol (trade name: REFINED GLYCEROL, Kao Corporation) and 57.9 g of water while warming. While agitating the resulting solution with a high-speed agitator (homogenizing mixer MARK II, manufactured by PRIMIX Corporation), a homogeneous mixture of 6.0 g of an orange flavor (manufactured by Takasago International Corporation), 2.4 g of sunflower lecithin (trade name: GIRALEC Premium, manufactured by Lasenor) and 0.3 g of vitamin E (manufactured by Eisai Co., Ltd.) was added and the resultant was subjected to an emulsification treatment at 9000 rpm for 10 minutes to prepare an emulsified flavor composition. The composition (% by weight) of the emulsified flavor composition of Example 9 is shown in Table 9.

TABLE 9

| | | HLB | Transmittance* | Example 9 |
|---|---|---|---|---|
| Orange flavor | | | | 2.0 |
| Vitamin E | | | | 0.1 |
| Polyglycerol fatty | Decaglyn 1-SVEX | 12.5 | 85.5% | 0.6 |
| acid ester | | | | |

| | |
|---|---|
| Sunflower lecithin | 0.8 |
| Glycerol | 77.2 |
| Water | 19.3 |
| Total | 100.0 |
| Part by weight of polyglycerol fatty acid ester to 100 parts | 29 |
| by weight of oil-soluble content | |
| Part by weight of lecithin to 100 parts by weight of | 133 |
| polyglycerol fatty acid ester | |
| Part by weight of lecithin to 100 parts by weight | 38 |
| of oil-soluble content | |

*Transmittance of 1% by weight aqueous solution of polyglycerol fatty acid ester at 600 nm

### [Test Example 8] Stability of Emulsified State

Water was added to 526 ml of 95% ethanol, 280 g of fructose-glucose syrup, 16 g of citric acid and 4.5 g of sodium citrate to make a 1000 ml solution, thereby preparing a five-times concentrated syrup of an alcoholic beverage (alcohol concentration: 50% by volume). To this five-times concentrated syrup, 0.15% by weight of the emulsified flavor composition prepared in Example 9 was added, which was homogeneous and showed good emulsion stability even after a week.

### [Test Example 9] Evaluation of Transparency when Diluted to Drinking Concentration

The five-times concentrated syrup (Example 9) that was subjected to one-week evaluation in Test example 8 was further diluted 5 times with water to prepare an alcoholic beverage. Subsequently, transparency of the resultant was evaluated by visual observation and transmittance measurement, where it had transparent appearance and transmittance of 98.9%. Even when the emulsified flavor composition prepared in Example 9 was added to a five-times concentrated syrup, stored at room temperature for a week and diluted 5 times with water, it gave a homogeneous alcoholic beverages with transparent appearance.

As described above, an emulsified flavor composition for alcoholic beverages of the present invention can provide transparent appearance and high palatability to an alcoholic beverage with which it is blended. Even when the emulsified flavor composition is mixed with a concentrated syrup for alcoholic beverages containing a high-concentration alcohol, it does not generate a floating matter or a sediment and can maintain a stable emulsified state. In addition, according to a preferable embodiment of the present invention, an emulsified flavor composition for alcoholic beverages of the present invention does not impair the taste/flavor of an alcoholic beverage product. Therefore, the emulsified flavor composition for alcoholic beverages of the present invention is useful as an emulsified flavor composition for alcoholic beverages.

### INDUSTRIAL APPLICABILITY

An emulsified flavor composition for alcoholic beverages of the present invention can be used to provide an alcoholic beverage and a concentrated syrup for alcoholic beverages, which have transparent appearance, high palatability and taste/flavor.

1. An emulsified flavor composition for alcoholic beverages, comprising:
(a) an oil-soluble component containing a flavor;
(b) a polyglycerol fatty acid ester whose 1% by weight aqueous solution has transmittance of 65% or higher at 600 nm; and
(c) lecithin.

2. The emulsified flavor composition for alcoholic beverages according to claim 1, wherein (c) the lecithin is not enzymatically modified.

3. The emulsified flavor composition for alcoholic beverages according to claim 1, wherein (b) the polyglycerol fatty acid ester is an ester of decaglycerol and a fatty acid selected from stearic acid, oleic acid or a combination thereof.

4. The emulsified flavor composition for alcoholic beverages according to claim 1, which comprises 20-135 parts by weight of (c) the lecithin to 100 parts by weight of (b) the polyglycerol fatty acid ester.

5. An alcoholic beverage comprising the emulsified flavor composition according to claim 1.

6. A concentrated syrup for alcoholic beverages comprising the emulsified flavor composition according to claim 1.

7. The concentrated syrup for alcoholic beverages according to claim 6, wherein the alcohol concentration of the concentrated syrup for alcoholic beverages is 20% or higher by volume.

8. A method for producing an alcoholic beverage by diluting the concentrated syrup according to claim 6.
